(19) United States
(12) Patent Application Publication
(10) Pub. No.: US 2020/0074827 A1
(43) Pub. Date: Mar. 5, 2020

(54) DETECTION OF THE PRESENCE OF ICE IN A TOTAL-AIR-TEMPERATURE PROBE

(71) Applicant: Airbus Operations SAS, TOULOUSE (FR)

(72) Inventors: Joris SCATTOLIN, TOULOUSE (FR); Benoît DAZET, TOULOUSE (FR)

(21) Appl. No.: 16/552,106

(22) Filed: Aug. 27, 2019

(30) Foreign Application Priority Data
Aug. 29, 2018 (FR) 18 57750

(51) Int. Cl. G08B 19/02; B64D 15/20

(52) U.S. Cl. CPC G08B 19/02; B64D 15/20

(57) ABSTRACT

A system for detecting the presence of ice in a total-air-temperature probe with which an aircraft is equipped monitors the slope of total-air-temperature measurements carried out by the total-air-temperature probe, and monitors the slope of a temperature differential, which is the difference between a static-air-temperature value and a temperature value according to the ISA model, determined depending on the altitude of the aircraft. The presence of ice in the total-air-temperature probe is detected when the total air temperature measured by the total-air-temperature probe exhibits a positive slope higher than a first predefined positive threshold and when in addition the temperature differential simultaneously exhibits a positive slope higher than a second predefined positive threshold. Thus, the detection of the presence of ice is possible whatever the flight phase of the aircraft.

### CROSS-REFERENCES TO RELATED APPLICATIONS

This application claims the benefit of the French patent application No. 1857750 filed on Aug. 29, 2018, the entire disclosures of which are incorporated herein by way of reference.

### FIELD OF THE INVENTION

The present invention relates to detection of the presence of ice in a total-air-temperature probe in an aircraft, and therefore to biased measurements carried out by the total-air-temperature probe, and also relates to an estimation of the total air temperature to be used as flight-control datum in the aircraft instead of the biased measurements.

### BACKGROUND OF THE INVENTION

Total air temperature (TAT) is a flight-control datum in an aircraft. The total air temperature is typically obtained by virtue of temperature probes, called TAT probes, that are placed on the skin of the fuselage of the aircraft in order to measure the temperature of the air flow around the aircraft. TAT probes may be subject to icing. In order to remedy this problem, TAT probes are heated. However, in the presence of ice crystals in the air, as may be the case in clouds of cumulonimbus type, or in the presence of supercooled water, TAT probes may at times fill with ice faster than they are capable of removing it, this possibly altering the measured temperature.

In U.S. Pat. No. 9,733,135 B2, a system and method for automatically detecting whether a measurement of total air temperature by the TAT probes of an aircraft is biased by the presence of ice is provided. The total-air-temperature measurements detected as being biased are then excluded from the flight-control datum of the aircraft. The proposed system and method are particularly effective when the variations in the altitude and speed of the aircraft are contained in a predefined interval margin.

It would thus be desirable to provide a solution that would allow situations in which ice is present in TAT probes to be more finely detected, in particular whatever the flight phase (ascent, cruise, descent). It would also be desirable to provide a solution able to continuously deliver a total-air-temperature value that has the least possible bias despite the potential presence of ice in the TAT probes.

### SUMMARY OF THE INVENTION

One aim of the present invention is to provide a method for detecting the presence of ice in a total-air-temperature probe with which an aircraft is equipped, the method being implemented by a system for detecting the presence of ice, which monitors the slope of total-air-temperature measurements carried out by the total-air-temperature probe. The method is such that the system for detecting the presence of ice furthermore carries out the following steps: monitoring the slope of a temperature differential ΔISA, which is the difference between a static-air-temperature value and a temperature value according to the ISA model (ISA being the acronym of International Standard Atmosphere), determined depending on the altitude of the aircraft; and detecting the presence of ice in the total-air-temperature probe when the total air temperature measured by the total-air-temperature probe exhibits a positive slope higher than a first predefined positive threshold TH1 and when in addition the temperature differential ΔISA simultaneously exhibits a positive slope higher than a second predefined positive threshold TH2. Thus, because the slope of the temperature differential ΔISA is taken into account in addition to the slope of the total-air-temperature measurements carried out by the total-air-temperature probe, it is possible to detect the presence of ice whatever the flight phase (ascent, cruise, descent) of the aircraft.

According to one particular embodiment, the system for detecting the presence of ice next carries out the following step: detecting that the ice has disappeared from the total-air-temperature probe when the total air temperature measured by the total-air-temperature probe exhibits a negative slope higher in absolute value than a third predefined positive threshold TH3 and when in addition the temperature differential ΔISA simultaneously exhibits a negative slope higher in absolute value than a fourth predefined positive threshold TH4.

According to one particular embodiment, to consider that the ice has actually disappeared from the total air temperature probe, the system for detecting the presence of ice waits for the total-air-temperature measurements carried out by the total-air-temperature probe to be consistent with the total-air-temperature measurements carried out by a reference probe or with total-air-temperature estimations calculated based on the altitude of the aircraft and on the temperature differential ΔISA to which a predefined delay has been applied.

Another aim of the present invention is to provide a method for determining the total air temperature to be used as flight-control datum of an aircraft, the method being implemented by a system for determining total air temperature comprising a system for detecting the presence of ice implementing the aforementioned method. The system for determining total air temperature furthermore comprises a system for estimating total air temperature, which calculates total-air-temperature estimations based on the altitude of the aircraft and on the temperature differential ΔISA to which a predefined delay has been applied, the method being such that the system for determining total air temperature carries out the following steps: selecting, as total air temperature to be used as flight-control datum of the aircraft, the total air temperature estimated by the system for estimating total air temperature when ice is detected to be present in the total-air-temperature probe; and otherwise, selecting as total air temperature to be used as flight-control datum of the aircraft, the total air temperature measured by the total-air temperature probe. Thus, it is possible to continuously deliver a total-air-temperature value that has the least possible bias despite the potential presence of ice in the total-air-temperature probes.

According to one particular embodiment, the total-air-temperature estimations TAT* are calculated as follows:

$${SAT}^{*} = min ( 15 - 1.98 * \frac{A}{1000} ; - 56.5 ) + Δ {ISA}_{d}$$

$$with$$

$${TAT}^{*} = {SAT}^{*} * ( 1 + 0.2 * {M}^{2} )$$

where A is the altitude of the aircraft, ΔISA_{d} is the delayed temperature differential ΔISA, and SAT* represents static-air-temperature estimations that correspond to the total-air-temperature estimations TAT* corrected for the effects of the speed of the aircraft.

According to one particular embodiment, the system for determining total air temperature switches from the estimated total-air-temperature value TAT* to the total-air-temperature value measured by the total-air-temperature probe when the total-air-temperature measurements carried out by the total-air-temperature probe are consistent with the total-air-temperature estimations calculated by the system for estimating total air temperature.

According to one particular embodiment, the system for determining total air temperature switches from the estimated total-air-temperature value TAT* to the total-air-temperature value measured by the total-air-temperature probe when the total-air-temperature measurements carried out by the total-air-temperature probe are consistent with the total-air-temperature measurements carried out by a reference probe.

Another aim of the present invention is to provide a computer-program product, which may be stored on a medium and/or downloaded from a communication network, in order to be read by a processor of the circuitry of the aforementioned control system. This computer program contains instructions for implementing either one of the aforementioned methods in any one of their embodiments, when the program is executed by the processor. Another aim of the present invention is to provide a data-storage medium on which such a computer program is stored.

Another aim of the present invention is to provide a system for detecting the presence of ice in a total-air-temperature probe with which an aircraft is equipped, the system for detecting the presence of ice comprising means for monitoring the slope of total-air-temperature measurements carried out by the total-air-temperature probe. The system for detecting the presence of ice furthermore comprises: means for monitoring the slope of a temperature differential ΔISA, which is the difference between a static-air-temperature value and a temperature value according to the ISA model, determined depending on the altitude of the aircraft; and means for detecting the presence of ice in the total-air-temperature probe when the total air temperature measured by the total-air-temperature probe exhibits a positive slope higher than a first predefined positive threshold TH1 and when in addition the temperature differential ΔISA simultaneously exhibits a positive slope higher than a second predefined positive threshold TH2.

Another aim of the present invention is to provide an aircraft comprising a total-air-temperature probe and a system, such as the aforementioned, for detecting the presence of ice in the total-air-temperature probe.

Another aim of the present invention is to provide a system for determining the total air temperature to be used as flight-control datum of an aircraft, the system for determining total air temperature comprising the system for detecting the presence of ice mentioned above. The system for determining total air temperature furthermore comprises a system for estimating total air temperature comprising means for calculating total-air-temperature estimations based on the altitude of the aircraft and on the temperature differential ΔISA to which a predefined delay has been applied and: means for selecting, as the total air temperature to be used as flight-control datum of the aircraft, the total air temperature estimated by the system for estimating total air temperature when ice is detected to be present in the total-air-temperature probe; and means for otherwise selecting, as the total air temperature to be used as flight-control datum of the aircraft, the total air temperature measured by the total-air-temperature probe.

Another aim of the present invention is to provide an aircraft comprising a total-air-temperature probe and a system, such as the aforementioned, for determining the total air temperature to be used as flight-control datum of the aircraft.

### BRIEF DESCRIPTION OF THE DRAWINGS

The aforementioned features of the invention, and others, will become more clearly apparent on reading the following description of at least one example embodiment, the description being given with reference to the appended drawings, in which:

FIG. 1 shows a side view of an aircraft equipped with a system for determining total air temperature;

FIG. 2 schematically illustrates an arrangement of the system for determining total air temperature, according to a first embodiment;

FIG. 3 schematically illustrates an arrangement of the system for determining total air temperature, according to a second embodiment;

FIG. 4 schematically illustrates a flowchart of an algorithm for determining total air temperature;

FIG. 5 schematically illustrates a state machine implemented by the system for determining total air temperature, in one particular embodiment; and

FIG. 6 schematically illustrates a temperature curve measured by a total-air-temperature probe, in the case of presence of ice.

### DETAILED DESCRIPTION OF THE PREFERRED EMBODIMENTS

FIG. 1 schematically illustrates, seen from the side, an aircraft 100. The aircraft 100 comprises a system 101 for determining total air temperature. The system 101 for determining total air temperature is connected to at least one TAT probe 200 placed on the skin of the fuselage of the aircraft 100 in order to measure the temperature of the air flow around the aircraft 100. In the case of a plurality of TAT probes 200, the system 101 for determining total air temperature is capable of independently tracking the behavior of each TAT probe 200 and of deducing therefrom whether the measurement carried out by the TAT probe 200 in question is biased or not.

The system 101 for determining total air temperature comprises two main functional units: a system 101a for detecting the presence of ice and a system 101b for estimating total air temperature, which takes over when the measurements delivered by the TAT probe 200 in question are detected to be biased.

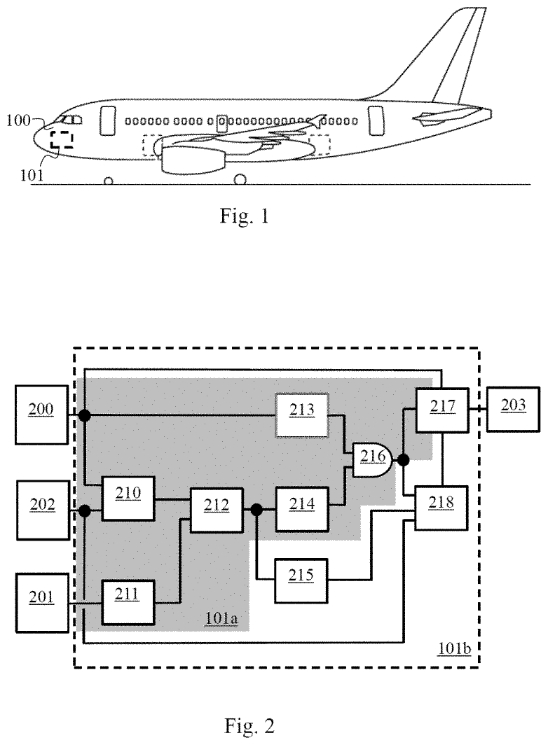

FIG. 2 schematically illustrates an arrangement of the system 101 for determining total air temperature, according to a first embodiment. FIG. 2 thus schematically illustrates the system 101 for determining total air temperature, the TAT probe 200, a device 201 for delivering altitude information, a device 202 for delivering information on Mach number, and a device 203 for delivering information on total air temperature. In FIG. 2, the constituent units of the system 101a for detecting the presence of ice are shown on a grey background, the other units forming the system 101b for estimating total air temperature, which is overlaid on the system 101a for detecting the presence of ice.

The device 201 for delivering altitude information and the device 202 for delivering information on Mach number are connected to the input of the system 101 for determining total air temperature. The device 201 for delivering altitude information is an altimeter, or a computer that determines altitude by virtue in particular of static pressure probes, or a device (such as a register or a memory zone or an interface) that collects the altitude information delivered by the altimeter or the computer. The device 202 for delivering information on Mach number is a Machmeter, or a computer that determines the Mach number by virtue in particular of the static pressure probes, or a device (such as a register or a memory zone or an interface) that collects information on Mach number delivered by the Machmeter or the computer.

The device 203 for delivering information on total air temperature is intended to deliver the information on total air temperature to the pilots of the aircraft 100 and/or to flight instruments of the aircraft 100. For example, the device 203 for delivering information on total air temperature is a display, or a register, or a memory zone, or an interface or a combination thereof.

In FIG. 2, the system 101 for determining total air temperature comprises a module 210 for computing static air temperature (SAT). The module 210 for computing static air temperature SAT receives as input the information on Mach number delivered by the device 202, and the total air temperature delivered by the one or more TAT probes 200. Static air temperature SAT is determined from the total air temperature TAT, and the Mach number using the following formula:

SAT=TAT/(1+0.2*M²)

where M is the Mach number.

The system 101 for determining total air temperature furthermore comprises a module 211 for determining temperature according to the ISA model. Standardized atmosphere is spoken of. The module 211 for determining temperature according to the ISA model thus receives as input the altitude information delivered by the device 201, and deduces therefrom, by virtue of charts and/or mathematical formulae, what the theoretical temperature is outside the aircraft 100. The ISA model is widely used in avionics and there is therefore no need to describe it in detail here.

The system 101 for determining total air temperature furthermore comprises a module 212 for computing a temperature differential ΔISA, which receives as input the information on static air temperature SAT delivered by the module 210 for computing static air temperature SAT, and the temperature according to the ISA model delivered by the module 211 for determining temperature according to the ISA model, and which computes the difference therebetween. In the case of presence of ice in the TAT probe 200, the measured temperature tends rapidly to 0° C. This creates a rapid variation in the temperature differential ΔISA computed from the measurements carried out by the TAT probe 200, whatever the flight phase (ascent, cruise, descent), whereas if the total air temperature varies greatly because of significant variations in the altitude and/or speed of the aircraft 100, the temperature differential ΔISA remains stable.

Such as described below, the system 101 for determining total air temperature monitors the slope of the total air temperature measured by the TAT probe 200 with respect to a threshold TH1, called the first threshold, and a threshold TH3, called the third threshold; in addition, the system 101 for determining total air temperature monitors the slope of the temperature differential ΔISA with respect to a threshold TH2, called the second threshold, and a threshold TH4, called the fourth threshold.

The system 101 for determining total air temperature furthermore comprises a module 214 for monitoring the slope of the temperature differential ΔISA. The module 214 for monitoring the slope of the temperature differential ΔISA carries out an integration over a predefined duration of samples of the temperature differential ΔISA delivered by the module 212 for calculating temperature differential ΔISA and deduces therefrom a value of the slope of the temperature differential ΔISA. When the temperature differential ΔISA has a positive slope that exceeds the second positive predefined threshold TH2, the module 214 for monitoring the slope of the temperature differential ΔISA delivers as output a first triggering signal representative of a detection of the presence of ice in the TAT probe 200. When the temperature differential ΔISA has a negative slope that exceeds in absolute value the fourth positive predefined threshold TH4, the module 214 for monitoring the slope of the temperature differential ΔISA delivers as output a first triggering signal representative of a detection of the disappearance of the ice from the TAT probe 200.

The system 101 for determining total air temperature furthermore comprises a module 213 for monitoring the slope of the total air temperature measured by the TAT probe 200. The module 213 for monitoring the slope of the measured total air temperature carries out an integration over a predefined duration of samples of measurements carried out by the TAT probe 200 and deduces therefrom a value of the slope of the total air temperature measured by the TAT probe 200. When the total air temperature measured by the TAT probe 200 has a positive slope that exceeds the first positive predefined threshold TH1, the module 213 for monitoring the slope of the measured total air temperature delivers as output a second triggering signal representative of a detection of the presence of ice in the TAT probe 200. When the total air temperature measured by the TAT probe 200 has a negative slope that exceeds in absolute value the third positive predefined threshold TH3, the module 213 for monitoring the slope of the measured total air temperature delivers as output a second triggering signal representative of a detection of the disappearance of ice from the TAT probe 200.

The system 101 for determining total air temperature furthermore comprises a module 216 for detecting concomitant triggering, which receives as input the output of the module 213 for monitoring the slope of the measured total air temperature and the output of the module 214 for monitoring the slope of the temperature differential ΔISA. In the concomitant presence of the first triggering signal and of the second triggering signal, which both indicate a detection of the presence of ice in the TAT probe 200, the module 216 for detecting concomitant triggering delivers as output a signal indicating the detection of the presence of ice in the TAT probe 200. In the concomitant presence of the first triggering signal and of the second triggering signal, which both indicate a detection of the disappearance of ice from the TAT probe 200, the module 216 for detecting concomitant triggering delivers as output a signal indicating the detection of the disappearance of ice from the TAT probe 200. The module 216 for detecting concomitant triggering therefore in substance behaves as an AND logic gate (this being why it is shown as such schematically in FIG. 2).

The system 101 for determining total air temperature furthermore comprises a delaying module 215, which receives as input the temperature differential ΔISA delivered by the module 212 for computing temperature differential ΔISA and applies thereto a predefined delay Δt. As detailed below, the delaying module 215 is used to estimate total air temperature in the case of presence of ice in the TAT probe 200.

The system 101 for determining total air temperature furthermore comprises a module 218 for estimating total air temperature, which receives as input the temperature differential ΔISA delayed by the delaying module 215 and the altitude information delivered by the device 202. The module 218 for estimating total air temperature obtains the estimated total air temperature TAT* (expressed in degrees Celsius) in the following way:

$${SAT}^{*} = min ( 15 - 1.98 * \frac{A}{1000} ; - 56.5 ) + Δ {ISA}_{d}$$

$$with$$

$${TAT}^{*} = {SAT}^{*} * ( 1 + 0.2 * {M}^{2} )$$

where A is the altitude and ΔISA_{d} is the temperature differential ΔISA delayed by the delaying module 215 and where SAT* is the estimated static air temperature, i.e. the estimated total air temperature TAT* corrected for the effects of the speed of the aircraft 100. It will be noted that the constants present in the formula for static air temperature SAT* are deduced from the ISA model.

Given that, under normal conditions, the temperature differential ΔISA has a slow variation, which is negligible with respect to the time required by the TAT probe 200 to remove accumulated ice, and that static pressure probes are by nature much less subject to the accumulation of ice than the TAT probes 200, the estimated total air temperature TAT* may be used instead of the measured total air temperature TAT, for the time required by the TAT probe 200 to remove the ice.

The estimation is calculated on the basis of the temperature differential ΔISA delayed by the predefined delay Δt, so as not to be affected by a sudden arrival of ice in the TAT probe 200. The estimated total air temperature TAT* is thus computed using the temperature differential ΔISA obtained before the accumulation of ice in the TAT probe 200. The predefined delay Δt is defined beforehand accordingly. One way of proceeding is to input the output of the module 216 for detecting concomitant triggering into the module 218 for estimating total air temperature. Thus, on appearance of the detection signal representative of a detection of the presence of ice in the TAT probe 200 (which signal is delivered by the module 216 for detecting concomitant triggering), the module 218 for estimating total air temperature records the delayed temperature differentia ΔISA 1, which is delivered by the delaying module 215. The estimation is then calculated on the basis of the delayed temperature differential ΔISA such as recorded.

The system 101 for determining total air temperature furthermore comprises a selecting module 217, which receives as input the triggering signal output from the module 216 for detecting concomitant triggering, the total-air-temperature measurements carried out by the TAT probe 200 and the estimated total air temperature TAT* delivered by the module 218 for estimating total air temperature. When the detection signal indicates a detection of the presence of ice in the TAT probe 200, the selecting module 217 delivers, to the device 203, the estimated total-air-temperature value TAT*, and when the detection signal indicate a detection of the disappearance of ice from the TAT probe 200, the selecting module 217 delivers, to the device 203, the total-air-temperature value measured by the one or more TAT probes 200.

In one particular embodiment, the selecting module 217 waits for the total-air-temperature value measured by the TAT probe 200 to be consistent before switching its output from the estimated total-air-temperature value TAT* to the total-air-temperature value measured by the TAT probe 200. Ice is detected to have actually disappeared from the TAT probe 200 when this consistency is achieved (this explaining why, in FIG. 2, the selecting module 217 is partially included in the system 101a for detecting the presence of ice). The total-air-temperature value measured by the TAT probe 200 is consistent when it deviates by less than a predefined threshold from the estimated total-air-temperature value TAT* or when it deviates by less than the predefined threshold from the total-air-temperature value measured by a reference probe. A reference probe is a TAT probe that is not subject to the ice-accumulation situation in question.

FIG. 3 schematically illustrates an arrangement of the system 101 for determining total air temperature, according to a second embodiment. FIG. 3 thus schematically illustrates the system 101 for determining total air temperature, the TAT probe 200, the device 201 for delivering altitude information, the device 202 for delivering information on the Mach number, and the device 203 for delivering information on total air temperature.

In FIG. 3, the system 101 for determining total air temperature comprises, connected by a communication bus 310: a processor 301; a random-access memory 302; a read-only memory 303, for example an EEPROM (electrically-erasable programmable read-only memory); a storage unit 304, such as an HDD (hard disk drive), or a reader of a storage medium, such as an SD (secure digital) card reader; an input-output interface 305 allowing the system 101 for determining total air temperature to be connected to the TAT probe 200, to the device 201 for delivering altitude, to the device 202 for delivering Mach number, and to the device 203 for delivering information on total air temperature.

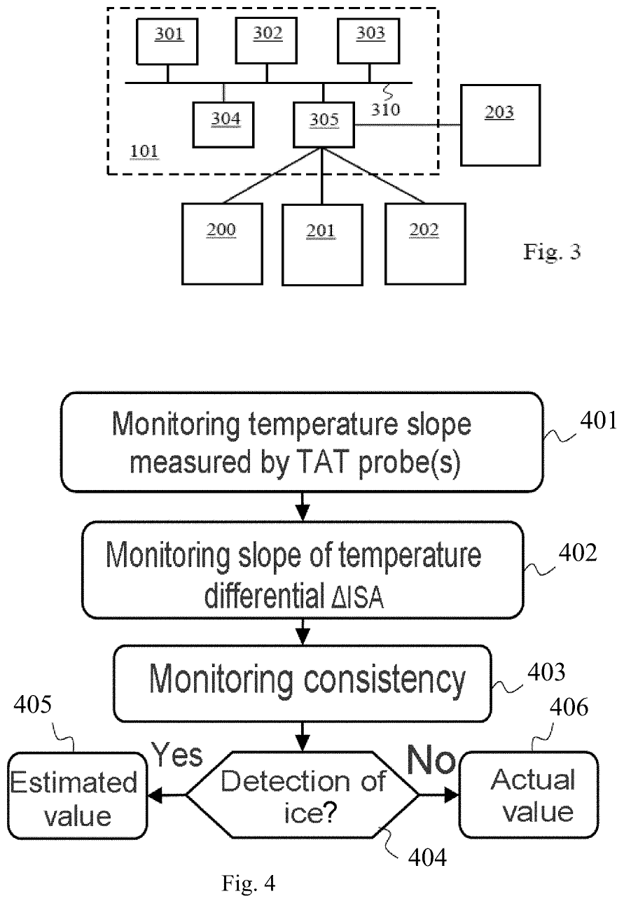

The processor 301 is capable of executing instructions loaded into the random-access memory 302 from the read-only memory 303, from an external memory, from a storage medium (such as an SD card), or from a communication network. When the system 101 for determining total air temperature is turned on, the processor 301 is able to read, from the random-access memory 302, instructions and to execute them. These instructions form a computer program that causes all or part of the algorithm and all or some of the steps described below with reference to FIG. 4 to be implemented by the processor 301.

All or part of the algorithm and all or some of the steps described below with reference to FIG. 4 may thus be implemented in software form, a set of instructions being executed by a programmable machine, for example a DSP (digital signal processor) or a microcontroller, or may be implemented in hardware form, using a machine or a dedicated component, an FPGA (field-programmable gate array) or ASIC (application-specific integrated circuit) for example. Generally, the system 101 for determining total air temperature comprises electronic circuitry designed and configured to implement, in software and/or hardware form, the algorithm described below with reference to FIG. 4.

FIG. 4 schematically illustrates a flowchart of an algorithm for determining total air temperature, which algorithm is implemented by the system 101 for determining total air temperature.

In a step 401, the system 101 for determining total air temperature monitors the slope of the total air temperature measured by the TAT probe 200, such as already described.

In a step 402, the system 101 for determining total air temperature monitors the slope of the temperature differential ΔISA, such as already described.

In an optional step 403, the system 101 for determining total air temperature monitors the consistency of the total air temperature measured by the TAT probe 200.

In a step 404, the system 101 for determining total air temperature checks whether the presence of ice has been detected in the TAT probe 200, according to the monitored slope of the total air temperature measured by the TAT probe 200 and the monitored slope of the temperature differential ΔISA. If the presence of ice has been detected, the system 101 for determining total air temperature delivers, in a step 405, the estimated total-air-temperature value TAT*; otherwise, the system 101 for determining total air temperature delivers, in a step 406, the total-air-temperature value measured by the TAT probe 200.

In one particular embodiment after the presence of ice has been detected in the TAT probe 200, the system 101 for determining total air temperature switches back to the total-air-temperature value measured by the TAT probe 200 only when the monitored consistency shows that the total-air-temperature value measured by the TAT probe 200 is consistent.

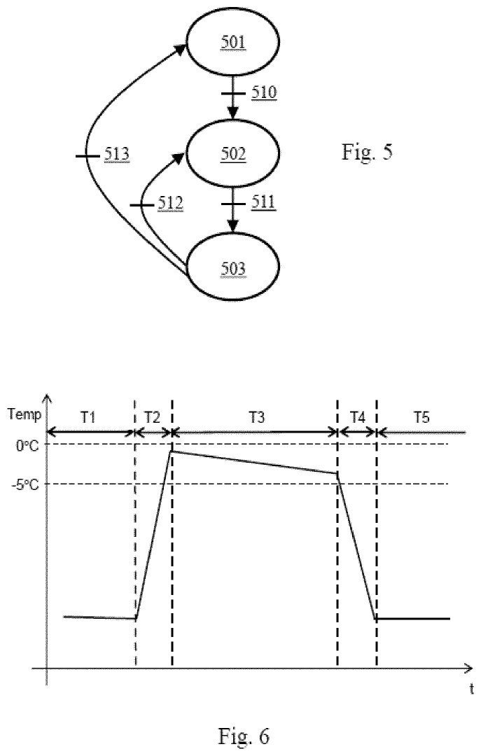

FIG. 5 schematically illustrates a state machine implemented by the system 101 for determining total air temperature, in one particular embodiment.

The state machine has three states 501, 502, 503. The state 501, which may be called the “nominal” state, corresponds to a nominal operating state of the TAT probe 200. No ice is detected to be present in the TAT probe 200. The total-air-temperature value measured by the TAT probe 200 is selected by the system 101 for determining total air temperature.

The state 502, which may be called the “freezing” state, corresponds to an operating state in which the presence of ice has been detected in the TAT probe 200. The estimated total-air-temperature value TAT* is selected by the system 101 for determining total air temperature.

The state 503, which may be called the “unfreezing” state, corresponds to an operating state in which the ice has started to disappear from the TAT probe 200. The estimated total-air-temperature value TAT* is selected by the system 101 for determining total air temperature, for as long as the total-air-temperature value measured by the TAT probe 200 is consistent with the estimated total-air-temperature value TAT*.

The transition 510 from the state 501 to the state 502 occurs when the total air temperature measured by the TAT probe 200 exhibits a positive slope higher than a first predefined positive threshold TH1 and when in addition the temperature differential ΔISA simultaneously exhibits a positive slope higher than the second predefined positive threshold TH2. It will be noted that, at this stage, the total-air-temperature value measured by the TAT probe 200 starts to significantly diverge from the estimated total-air-temperature value TAT*.

The transition 511 from the state 502 to the state 503 occurs when the total air temperature measured by the TAT probe 200 exhibits a negative slope higher in absolute value than the third predefined positive threshold TH3 and when in addition the temperature differential ΔISA simultaneously exhibits a negative slope higher in absolute value than the fourth predefined positive threshold TH4. It will be noted that, at this stage, the total-air-temperature value measured by the TAT probe 200 starts to significantly reconverge toward the estimated total-air-temperature value TAT*.

The transition 512 from the state 503 to the state 502 occurs when the total air temperature measured by the TAT probe 200 once again exhibits a positive slope higher than the first predefined positive threshold TH1 and when in addition the temperature differential ΔISA simultaneously once again exhibits a positive slope higher than the second predefined positive threshold TH2. In other words, metrological conditions have once again worsened and ice has once again accumulated in the TAT probe 200.

The transition 513 from the state 503 to the state 501 occurs when the total air temperature measured by the TAT probe 200 exhibits a negative slope lower in absolute value than the third predefined positive threshold TH3, when in addition the temperature differential ΔISA simultaneously exhibits a negative slope lower in absolute value than the fourth predefined positive threshold TH4 and when lastly the total-air-temperature value measured by the TAT probe 200 is consistent.

FIG. 6 schematically illustrates a curve of the temperature measured by the TAT probe 200, in the case of presence of ice.

During a period T1, the temperature measured by the one or more TAT probes 200 is largely below −5° C. Then, ice appears in the TAT probe 200, this requiring the estimated total air temperature TAT to be employed. Thus, during a period T2, which may last from one to three minutes, the temperature measured by the TAT probe 200 increases greatly, and stabilizes between −5° C. and 0° C. (or between −8° C. and 0° C.) during a period T3 that may last for up to about ten minutes. Next, during a period T4 that may last two to eight minutes, the TAT probe 200 succeeds in melting and removing the ice, and the temperature measured by the TAT probe 200 decreases greatly, in order to return to substantially the temperature level of the period T1. The temperature measured by the TAT probe 200 is once again perfectly reliable.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for detecting a presence of ice in a total-air-temperature probe with which an aircraft is equipped, the method being implemented by a system for detecting the presence of ice, which monitors a slope of total-air-temperature measurements carried out by the total-air-temperature probe,
wherein the system for detecting the presence of ice furthermore carries out the following steps:
monitoring a slope of a temperature differential, which is a difference between a static-air-temperature value and a temperature value according to an International Standard Atmosphere model, determined depending on an altitude of the aircraft;
detecting the presence of ice in the total-air-temperature probe when a total air temperature measured by the total-air-temperature probe exhibits a positive slope higher than a first predefined positive threshold and when, in addition, the temperature differential simultaneously exhibits a positive slope higher than a second predefined positive threshold; and
detecting that the ice has disappeared from the total-air-temperature probe when the total air temperature measured by the total-air-temperature probe exhibits a negative slope higher in absolute value than a third predefined positive threshold and when, in addition, the temperature differential exhibits a negative slope higher in absolute value than a fourth predefined positive threshold.

2. The method according to claim 1, wherein, to consider that the ice has actually disappeared from the total-air-temperature probe, the system for detecting the presence of ice waits for the total-air-temperature measurements carried out by the total-air-temperature probe to be consistent with the total-air-temperature measurements carried out by a reference probe or with total-air-temperature estimations calculated based on the altitude of the aircraft and on the temperature differential to which a predefined delay has been applied.

3. A method for determining a total air temperature to be used as flight-control datum of an aircraft, the method being implemented by a system for determining total air temperature comprising a system for detecting the presence of ice implementing the method according to claim 2, wherein the system for determining total air temperature furthermore comprises a system for estimating total air temperature, which calculates total-air-temperature estimations based on the altitude of the aircraft and on the temperature differential to which a predefined delay has been applied, the system for determining total air temperature carrying out the following steps:
selecting, as total air temperature to be used as flight-control datum of the aircraft, the total air temperature estimated by the system for estimating total air temperature when ice is detected to be present in the total-air-temperature probe; and
otherwise, selecting as total air temperature to be used as flight-control datum of the aircraft, the total air temperature measured by the total-air temperature probe.

4. The method according to claim 3, wherein the total-air-temperature estimations TAT* are calculated as follows:
$${SAT}^{*} = min ( 15 - 1.98 * \frac{A}{1000} ; - 56.5 ) + Δ {ISA}_{d}$$
$$with$$
$${TAT}^{*} = {SAT}^{*} * ( 1 + 0.2 * {M}^{2} )$$
where A is the altitude of the aircraft, ΔISA_{d} is the delayed temperature differential ΔISA, and SAT* represents static-air-temperature estimations that correspond to the total-air-temperature estimations TAT* corrected for effects of a speed of the aircraft.

5. The method according to claim 4, wherein the system for determining total air temperature switches from an estimated total-air-temperature value to a total-air-temperature value measured by the total-air-temperature probe when the total-air-temperature measurements carried out by the total-air-temperature probe are consistent with the total-air-temperature estimations calculated by the system for estimating total air temperature.

6. The method according to claim 3, wherein the system for determining total air temperature switches from an estimated total-air-temperature value to a total-air-temperature value measured by the total-air-temperature probe when the total-air-temperature measurements carried out by the total-air-temperature probe are consistent with the total-air-temperature measurements carried out by a reference probe.

7. A computer-program product comprising instructions that lead to an execution, by a processor, of the method according to claim 1, when said instructions are executed by the processor.

8. A computer-program product comprising instructions that lead to the execution, by a processor, of the method according to claim 3, when said instructions are executed by the processor.

9. A storage medium storing a computer program containing instructions that lead to an execution, by a processor, of the method according to claim 1, when said instructions are read and executed by the processor.

10. A storage medium storing a computer program containing instructions that lead to an execution, by a processor, of the method according to claim 3, when said instructions are read and executed by the processor.

11. A system for detecting a presence of ice in a total-air-temperature probe with which an aircraft is equipped, the system for detecting the presence of ice comprising means for monitoring a slope of total-air-temperature measurements carried out by the total-air-temperature probe, the system comprising:
means for monitoring a slope of a temperature differential, which is a difference between a static-air-temperature value and a temperature value according to an International Standard Atmosphere model, determined depending on an altitude of the aircraft;
means for detecting the presence of ice in the total-air-temperature probe when a total air temperature measured by the total-air-temperature probe exhibits a positive slope higher than a first predefined positive threshold and when in addition the temperature differential simultaneously exhibits a positive slope higher than a second predefined positive threshold; and
means for detecting that the ice has disappeared from the total-air-temperature probe when the total air temperature measured by the total-air-temperature probe exhibits a negative slope higher in absolute value than a third predefined positive threshold and when, in addition, the temperature differential exhibits a negative slope higher in absolute value than a fourth predefined positive threshold.

12. An aircraft comprising a total-air-temperature probe and a system for detecting the presence of ice in the total-air-temperature probe according to claim 11.

13. A system for determining the total air temperature to be used as flight-control datum of an aircraft, the system for determining total air temperature comprising the system for detecting the presence of ice according to claim 11,
wherein the system for determining total air temperature furthermore comprises a system for estimating total air temperature comprising means for calculating total-air-temperature estimations based on the altitude of the aircraft and on the temperature differential to which a predefined delay has been applied and:
means for selecting, as the total air temperature to be used as flight-control datum of the aircraft, the total air temperature estimated by the system for estimating total air temperature when ice is detected to be present in the total-air-temperature probe; and
means for otherwise selecting, as the total air temperature to be used as flight-control datum of the aircraft, the total air temperature measured by the total-air-temperature probe.

14. An aircraft comprising a total-air-temperature probe and a system for determining the total air temperature to be used as flight-control datum of the aircraft according to claim 13.
